(19) United States
(12) Patent Application Publication
(10) Pub. No.: US 2026/0170624 A1
(43) Pub. Date: Jun. 18, 2026

(54) ELECTRONIC DEVICE FOR DISPLAYING IMAGE AND METHOD FOR CONTROLLING SAME

(71) Applicant: SAMSUNG ELECTRONICS CO., LTD., Suwon-si (KR)

(72) Inventors: Junghoon CHO, Suwon-si (KR); Yongnam KIM, Suwon-si (KR); Jisun PARK, Suwon-si (KR); Sanghyun YI, Suwon-si (KR); Junil SOHN, Suwon-si (KR); Wonjun LEE, Suwon-si (KR)

(73) Assignee: SAMSUNG ELECTRONICS CO., LTD., Suwon-si (KR)

(21) Appl. No.: 19/532,580

(22) Filed: Feb. 6, 2026

Related U.S. Application Data
(63) Continuation of application No. PCT/KR2024/008895, filed on Jun. 26, 2024.

(30) Foreign Application Priority Data
Aug. 8, 2023 (KR) 10-2023-0103623

(51) Int. Cl. G06T 5/80; G06T 7/13

(52) U.S. Cl. CPC G06T 5/80; G06T 7/13; G06T 2207/20076; G06T 2207/20192

(57) ABSTRACT

An electronic device for displaying an image, includes: a display; memory storing at least one instruction; and at least one processor configured to execute the at least one instruction stored in the memory, wherein the at least one instruction, when executed by the at least one processor individually or collectively, causes the electronic device to: detect a boundary line from an original image, obtain a corrected image by converting a pixel detected as part of the boundary line into a binary value based on luminance values of a plurality of pixels located around the pixel detected as the part of the boundary line, and display the corrected image via the display.

### CROSS-REFERENCE TO RELATED APPLICATIONS

This application is a continuation of International Application No. PCT/KR2024/008895, filed on Jun. 26, 2024, which is based on and claims priority to Korean Patent Application No. 10-2023-0103623, filed on Aug. 8, 2023, in the Korean Intellectual Property Office, the disclosures of which are incorporated by reference herein in their entireties.

### BACKGROUND

### 1. Field

The disclosure relates to an electronic device for displaying an image and a method of controlling the electronic device, and more particularly, to an electronic device for displaying a corrected image that is obtained based on an original image, and a method of controlling the electronic device.

### 2. Description of Related Art

Boundary lines included in an image may be utilized by a user to understand the context of the image. In other words, the user may understand the context of the image by using the boundary lines included in the image to recognize objects or to perceive information about the objects.

### SUMMARY

According to an aspect of the disclosure, there is provided an electronic device for displaying an image, the electronic device including: a display; memory storing at least one instruction; and at least one processor configured to execute the at least one instruction stored in the memory, wherein the at least one instruction, when executed by the at least one processor individually or collectively, causes the electronic device to: detect a boundary line from an original image, obtain a corrected image by converting a pixel detected as part of the boundary line into a binary value based on luminance values of a plurality of pixels located around the pixel detected as the part of the boundary line, and display the corrected image via the display.

According to an aspect of the disclosure, there is provided a method of controlling an electronic device for displaying an image, the method including: detecting a boundary line from an original image; obtaining a corrected image by converting a pixel detected as part of the boundary line into a binary value based on luminance values of a plurality of pixels located around the pixel detected as the part of the boundary line; and displaying the corrected image on a display.

According to an aspect of the disclosure, there is provided a non-transitory computer-readable recording medium having recorded thereon a program that when executed by at least one processor of an electronic device, cause the electronic device to prepare a method of including: detect a boundary line from an original image, obtain a corrected image by converting a pixel detected as part of the boundary line into a binary value based on luminance values of a plurality of pixels located around the pixel detected as the part of the boundary line, and display the corrected image via the display.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic device according to an embodiment of the present disclosure;

FIG. 2 is a flowchart for describing operations of an electronic device, according to an embodiment of the present disclosure;

FIG. 3 is a diagram for describing a method, performed by an electronic device, of detecting boundary lines from an image, according to an embodiment of the present disclosure;

FIG. 4 is a flowchart for describing an operation, performed by an electronic device, of detecting boundary lines based on a boundary line thickness, according to an embodiment of the present disclosure;

FIG. 5 is a diagram for describing an operation, performed by an electronic device, of detecting boundary lines of different thicknesses by applying, to an original image, boundary line detection masks of different sizes, according to an embodiment of the present disclosure;

FIG. 6 is a flowchart for describing an operation, performed by an electronic device, of detecting boundary lines based on a boundary line thickness, according to an embodiment of the present disclosure;

FIG. 7 is a diagram for describing an operation, performed by an electronic device, of identifying second pixels located around first pixels that are identified by applying a boundary line detection mask, according to an embodiment of the present disclosure;

FIG. 8 is a flowchart for describing an operation, performed by an electronic device, of converting pixels detected as boundary lines into binary values, according to an embodiment of the present disclosure;

FIG. 9 is a diagram for describing an electronic device converting pixels detected as boundary lines into binary values, according to an embodiment of the present disclosure;

FIG. 10 is a diagram for describing an operation, performed by an electronic device, of obtaining an original image, according to an embodiment of the present disclosure;

FIG. 11 is a diagram for describing an operation, performed by an electronic device, of activating an operation mode for displaying a corrected image, according to an embodiment of the present disclosure;

FIG. 12 is a diagram for describing an operation, performed by an electronic device, of changing a color of a boundary line in a corrected image, according to an embodiment of the present disclosure;

FIG. 13 is a diagram for describing an operation, performed by an electronic device, of changing the transparency of a corrected image, according to an embodiment of the present disclosure; and

FIG. 14 is a diagram for describing a detailed configuration of an electronic device according to an embodiment of the present disclosure.

### DETAILED DESCRIPTION

Although the terms used herein for describing embodiments of the present specification are selected from among common terms that are currently widely used in consideration of their function in the present disclosure, the terms may be different according to an intention of those of ordinary skill in the art, a precedent, or the advent of new technology. Also, in particular cases, the terms are discretionally selected by the applicant of the present disclosure, in which case, the meaning of those terms will be described in detail in the corresponding embodiment. Therefore, the terms used herein are not merely designations of the terms, but the terms are defined based on the meaning of the terms and content throughout the present disclosure.

The singular expression may also include the plural meaning as long as it is not inconsistent with the context. All the terms used herein, including technical and scientific terms, may have the same meanings as those generally understood by those of skill in the art related to the present specification.

Throughout the present disclosure, when a part “includes” an element, it is to be understood that the part may additionally include other elements rather than excluding other elements as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

As used herein, the expression “configured to” may be interchangeably used with, for example, “suitable for”, “having the capacity to”, “designed to”, “adapted to”, “made to”, or “capable of”, according to a situation. The expression “configured to” may not imply only “specially designed to” in a hardware manner. Instead, in a certain circumstance, the expression “a system configured to” may indicate the system “capable of” together with another device or components. For example, “a processor configured (or set) to perform A, B, and C” may imply a dedicated processor (e.g., an embedded processor) for performing a corresponding operation or a generic-purpose processor (e.g., central processing unit (CPU) or an application processor) capable of performing corresponding operations by executing one or more software programs stored in memory.

In the present disclosure, a processor is a component configured to control a series of processes such that an electronic device operates according to embodiments to be described below, and may include one or more processors. The one or more processors included in the processor may be circuitry such as a system-on-chip (SoC) or an integrated circuit (IC). The one or more processors included in the processor may be general-purpose processors such as CPUs, microprocessor units (MPUs), application processors (APs), or digital signal processors (DSPs), dedicated graphics processors such as graphics processing units (GPUs) or vision processing units (VPUs), dedicated artificial intelligence processors such as neural processing units (NPUs), or dedicated communication processors such as communication processors (CPs). In a case in which the one or more processors included in the processor are dedicated artificial intelligence processors, the dedicated artificial intelligence processors may be designed with a hardware structure specialized for processing a particular artificial intelligence model.

In the present disclosure, a processor may include various types of processing circuitry and/or a plurality of processors. For example, the term “processor” as used herein, including in the claims, may include various types of processing circuitry including at least one processor. One or more of the at least one processor may be configured to individually and/or collectively perform various functions described herein in a distributed manner. As used herein, “processor,” “at least one processor,” and “one or more processors” may be configured to perform various functions. However, these terms cover, but are not limited to, situations where one processor performs some of the functions and other processor(s) perform the other functions, and situations where a single processor may perform all of the functions. In addition, the at least one processor may include a combination of processors configured to perform various functions disclosed herein in a distributed manner. The at least one processor may execute program instructions to achieve or perform various functions.

It should be understood that, in the present disclosure, blocks in each flowchart, and combinations of flowcharts may be performed by one or more computer programs including computer-executable instructions. The one or more computer programs may be all stored in a single memory unit, or may be divided and stored in a plurality of different memory units.

In the present disclosure, all functions or operations described herein may be performed by a single processor or a combination of processors. The processor or the combination of processors is circuitry configured to perform processing, and may include circuitries such as an AP, a CP, a GPU, an NPU, an MPU, an SoC, or an IC.

The processor may write data to memory or read data stored in the memory, and in particular, may process data according to a predefined operation rule or an artificial intelligence model by executing a program or at least one instruction stored in the memory. Accordingly, the processor may perform the operations described in the embodiments below, and unless described otherwise, operations described in the embodiments below as being performed by the electronic device or detailed components included in the electronic device may be regarded as being performed by the processor.

In the present disclosure, it should be understood that when components are “connected” or “coupled” to each other, the components may be directly connected or coupled to each other, but may alternatively be connected or coupled to each other with a component therebetween, unless specified otherwise.

In the present disclosure, the term “boundary line” may refer to a line or a region that represents a visual distinction between different regions within an image. A “boundary line” may separate regions within an image that have different attributes, such as color, contrast, texture, or shape. A user may understand the context of an image by using a “boundary line” included in the image to recognize objects or to perceive information about the objects.

In the present disclosure, the term “luminance value” may refer to a value that represents the brightness of a pixel. A luminance value may range from 0 to 255, inclusive, but is not limited thereto. A “luminance value” may be obtained in various ways depending on the purpose of the image processing, such as being obtained as a Y value according to a YCbCr conversion based on a value representing a color of a pixel, or being obtained based on an average of RGB channel values of a pixel.

In the present disclosure, the term “binarization” may refer to an image processing operation that converts a value of a pixel into a binary form, such as 0 or 1. As a result of “binarization”, a pixel having a value binarized to 0 may be displayed as black on a display, and a pixel having a value binarized to 1 may be displayed as white on the display. However, embodiments of the present disclosure are not limited to the above example, and as a result of “binarization”, a pixel having a value binarized to 1 may be displayed as black on a display, and a pixel having a value binarized to 0 may be displayed as white on the display.

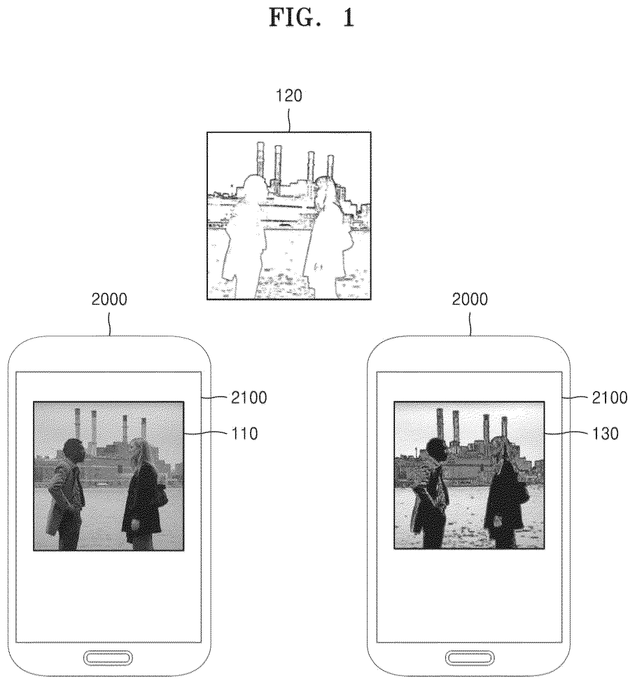

FIG. 1 is a diagram illustrating an electronic device according to an embodiment of the present disclosure.

In an embodiment, an electronic device 2000 may detect boundary lines 120 from an original image 110. In an embodiment, the boundary lines 120 extracted from the original image 110 may include lines that represent boundaries between different regions or different objects within the original image 110. For example, the boundary lines 120 extracted from the original image 110 may include, but are not limited to, lines representing a boundary between a building and the sky included in the original image 110, lines representing a boundary between a river and a person, lines representing shimmering river water, lines representing wrinkles on clothing, and the like.

In an embodiment, the electronic device 200 may obtain a corrected image 130 by converting pixels detected as the boundary lines 120 into binary values, based on luminance values of a plurality of pixels located around each of the pixels detected as the boundary lines 120. In an embodiment, the corrected image 130 may be an image in which pixels other than the pixels detected as the boundary lines 120 are identical to those of the original image 110, and only the pixels detected as the boundary lines 120 are converted into binary values.

In an embodiment, the electronic device 2000 may display the obtained corrected image 130 on a display. In an embodiment, the corrected image 130 may include pixels detected as the boundary lines, wherein their pixel values are binarized to 0 when the luminance values of surrounding pixels are high, and binarized to 1 when the luminance values of surrounding pixels are low. In other words, in the corrected image 130, boundary lines located close to bright regions may be displayed as black, and boundary lines located close to dark regions may be displayed as white. Accordingly, the contrast sensitivity for the boundary lines 120 of the corrected image 130 may be higher than that of the original image 110.

As such, according to an embodiment of the present disclosure, the visibility of an image may be improved by displaying, on a display 2100, the corrected image 130, which enables higher contrast sensitivity for the boundary lines 120 compared to the original image 110.

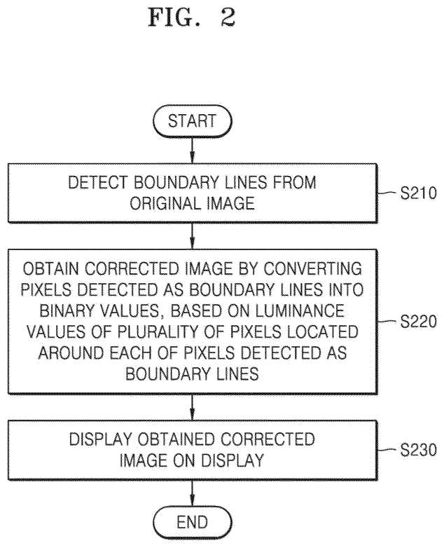

FIG. 2 is a flowchart for describing operations of an electronic device, according to an embodiment of the present disclosure.

In operation S210, the electronic device 2000 may detect boundary lines from an original image. Here, detecting the boundary lines may refer to identifying, among a plurality of pixels of the original image, pixels that are detected as boundary lines.

In an embodiment, the electronic device 2000 may detect the boundary lines by applying a boundary line detection mask to the original image. In an embodiment, the boundary line detection mask may refer to a filter or kernel of a preset size for calculating gradients that represent the degree of change in the luminance values of a plurality of pixels located within the range to which the boundary line detection mask is applied. In an embodiment, the electronic device 2000 may calculate the gradients of a plurality of pixels of the original image by applying the boundary line detection mask to the original image. In an embodiment, the electronic device 2000 may identify pixels detected as boundary lines from among the plurality of pixels of the original image, based on the calculated gradients.

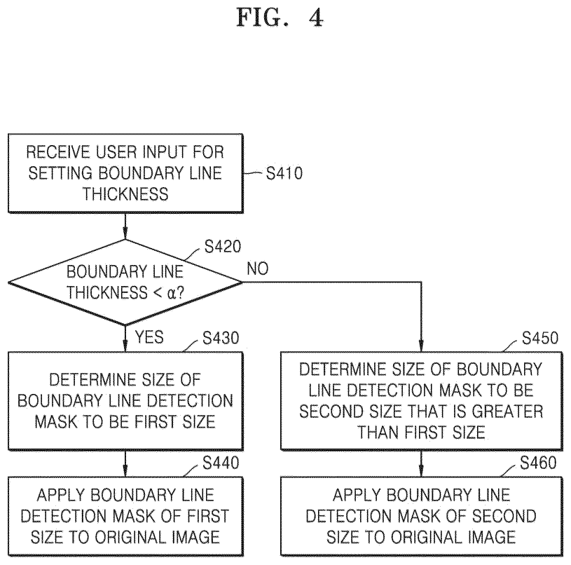

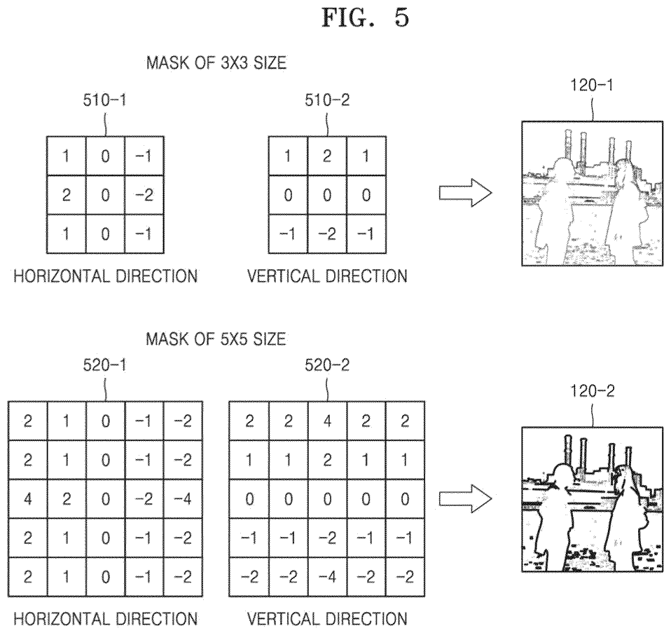

In an embodiment, the electronic device 2000 may receive a user input for setting a boundary line thickness. In an embodiment, the electronic device 2000 may determine the size of the boundary line detection mask based on a result of comparing the boundary line thickness, which is set based on the received user input, with a preset threshold value. In an embodiment, the electronic device 2000 may detect boundary lines by applying, to the original image, the boundary line detection mask having the determined size. Details regarding this process will be described below with reference to FIGS. 4 and 5.

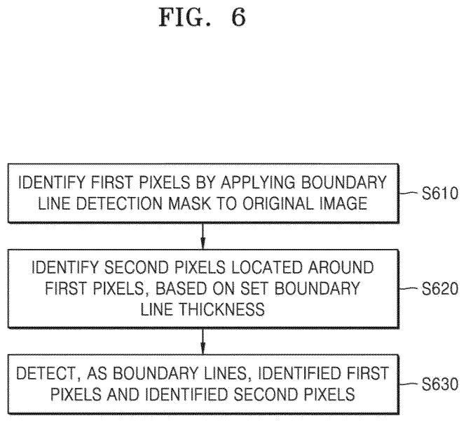

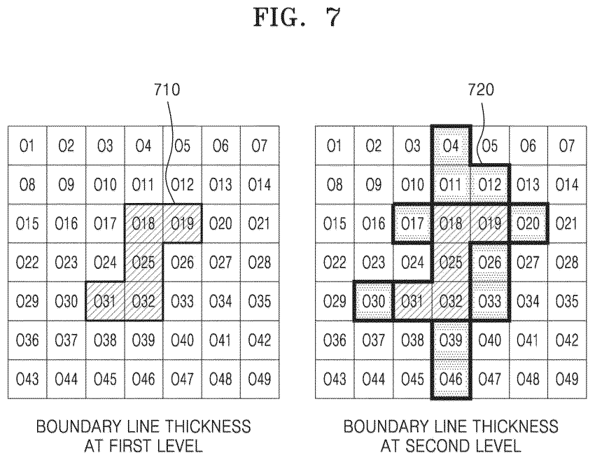

In an embodiment, the electronic device 2000 may identify first pixels by applying the boundary line detection mask to the original image. In an embodiment, the electronic device 2000 may identify second pixels located around the first pixels, based on the set boundary line thickness. In an embodiment, the electronic device 2000 may detect, as boundary lines, the identified first pixels and the identified second pixels. Details regarding this process will be described below with reference to FIGS. 6 and 7.

In operation S220, the electronic device 2000 may obtain a corrected image by converting the pixels detected as boundary lines into binary values, based on luminance values of a plurality of pixels located around each of the pixels detected as boundary lines. In an embodiment, the electronic device 2000 may obtain a corrected image in which the pixels detected as boundary lines from among the plurality of pixels of the original image are converted into binary values, and the remaining pixels are identical to those of the original image.

In an embodiment, the electronic device 2000 may calculate an average of luminance values of a plurality of pixels located around a pixel detected as part of the boundary lines. In an embodiment, the electronic device 2000 may convert the pixel detected as part of the boundary lines into a binary value, based on the calculated average of the luminance values.

In an embodiment, when the calculated average of the luminance values is greater than or equal to a preset threshold value, the electronic device 2000 may binarize the value of the pixel detected as part of the boundary lines to 0. In an embodiment, when the calculated average of the luminance values is less than the preset threshold value, the electronic device 2000 may binarize the value of the pixel detected as part of the boundary lines to 1. In an embodiment, pixels detected as boundary lines and having values binarized to 0 may be displayed as black on a display, by converting their pixel values representing luminance to a minimum value, or by converting their values representing color to correspond to black. In an embodiment, pixels detected as boundary lines and having values binarized to 1 may be displayed as white on a display, by converting their pixel values representing luminance to a maximum value, or by converting their values representing color to correspond to white.

In an embodiment, when the calculated average of the luminance values is greater than or equal to a preset threshold value, the electronic device 2000 may binarize the value of the pixel detected as part of the boundary lines to 1. In an embodiment, when the calculated average of the luminance values is less than the preset threshold value, the electronic device 2000 may binarize the value of the pixel detected as part of the boundary lines to 0. In an embodiment, pixels detected as boundary lines and having values binarized to 1 may be displayed as black on a display, by converting their pixel values representing luminance to a minimum value, or by converting their values representing color to correspond to black. In an embodiment, pixels detected as boundary lines and having values binarized to 0 may be displayed as white on a display, by converting their pixel values representing luminance to a maximum value, or by converting their values representing color to correspond to white.

In operation S230, the electronic device 2000 may display the obtained corrected image on a display. In an embodiment, the electronic device 2000 may display the obtained corrected image on the display instead of the original image that was being displayed. However, embodiments of the present disclosure are not limited to the above example, and the electronic device 2000 may display the original image and the corrected image together on the display.

In an embodiment, the electronic device 2000 may receive a user input for setting a boundary line color. In an embodiment, the electronic device 2000 may convert pixel values, which represent the colors of the pixels converted into binary values in the corrected image, to correspond to a boundary line color that is set based on the received user input. In an embodiment, when a user input for selecting any one of a plurality of preset colors is received, the electronic device 2000 may identify a pixel value representing the preset color selected by the received user input, and convert, to the identified pixel value, the pixel values representing the colors of the pixels converted into binary values.

In an embodiment, the electronic device 2000 may receive a user input for setting image transparency. In an embodiment, the electronic device 2000 may convert pixel values representing the transparency of other pixels than those converted into binary values in the corrected image, to a value corresponding to the image transparency that is set via the received user input. In an embodiment, the transparency may refer to a value represented via an alpha channel among pixel values. In an embodiment, when a user input for selecting any one of a plurality of preset transparency levels is received, the electronic device 2000 may identify an alpha channel value corresponding to the transparency level selected by the received user input, and convert, to the identified alpha channel value, pixel values representing the transparency of the other pixels than those converted into binary values in the corrected image.

In an embodiment, the electronic device 2000 may obtain, as an original image, image content that is displayed on the display when an application is executed. In an embodiment, when an application is executed, the electronic device 2000 may obtain, via an application programming interface (API) of the executed application, an image file displayed as image content, and obtain an image of the obtained image file as an original image. In an embodiment, the electronic device 2000 may identify image content on an application screen that is displayed on the display when an application is executed. In an embodiment, the electronic device 2000 may obtain an original image by setting a region displayed as image content on the application screen, and identifying the set region as image content. In an embodiment, the region displayed as image content may be set based on a user input. However, the present disclosure is not limited to the above example, and the electronic device 2000 may obtain an original image by using a learning model that is trained to receive an application screen as an input and identify image content included in the application screen.

In an embodiment, the electronic device 2000 may receive a user input for executing an operation mode for displaying a corrected image. In an embodiment, the electronic device 2000 may obtain an original image as the operation mode is activated by the received user input. In an embodiment, the electronic device 2000 may display the original image on the display when the operation mode for displaying a corrected image is deactivated, and may obtain an original image and display a corrected image on the display when the operation mode for displaying a corrected image is activated. In an embodiment, the electronic device 2000 may display the corrected image, instead of the original image, in the region where the original image is displayed, or may display the corrected image in a region different from the region where the original image is displayed.

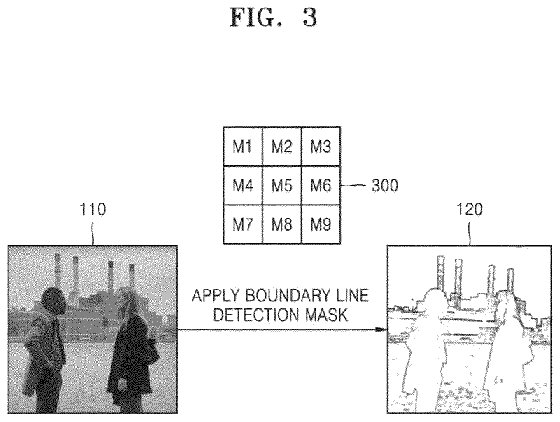

FIG. 3 is a diagram for describing a method, performed by an electronic device, of detecting boundary lines from an image, according to an embodiment of the present disclosure.

In an embodiment, the electronic device 2000 may detect the boundary lines 120 by applying a boundary line detection mask 300 to the original image 110.

In an embodiment, the boundary line detection mask 300 may include a preset weight for each of a plurality of pixels in a region to which the mask is applied. In an embodiment, the values of the weights of the boundary line detection mask may be set based on the direction of a gradient to be calculated. For example, in the boundary line detection mask, the weights of a horizontal boundary line detection mask for calculating a gradient in a horizontal direction may be set to be different from the weights of a vertical boundary line detection mask for calculating a gradient in a vertical direction. However, embodiments of the present disclosure are not limited to the above example, and the weights of the boundary line detection mask may be set for calculating a gradient in a diagonal direction or an arbitrary angular direction. In an embodiment, the weights of the boundary line detection mask may have various values according to the type and purpose of the boundary line detection algorithm.

In an embodiment, the electronic device 2000 may convert the original image 110 into a grayscale image. In an embodiment, a grayscale image may refer to an image in which the colors of a plurality of pixels are represented only by luminance values, by converting the pixel values representing the colors of the pixels into corresponding luminance values. In an embodiment, the electronic device 2000 may calculate luminance values of a plurality of pixels of the original image 110 by using various types of grayscale conversion formulas. For example, the luminance values may be calculated based on Equation 1 below.

$$Y = 0.2999 R + 0.587 G + 0.114 B \qquad [ Equation 1 ]$$

Equation 1 is used to calculate a luminance value Y in a YCbCr conversion. Here, R, G, and B may refer to the pixel values of the RGB color channels of the pixel on which the conversion is performed. However, embodiments of the present disclosure are not limited to the above example, and the luminance value may be calculated based on various formulas for calculating a brightness value or luminance value of a pixel, such as being calculated as an average of pixel values for the RGB color channels of the pixel on which the conversion is performed.

In an embodiment, the electronic device 2000 may apply a boundary line detection mask to the grayscale-converted original image 110. In an embodiment, applying a boundary line detection mask to an image may refer to calculating gradients of a plurality of pixels included in the image. In an embodiment, the electronic device 2000 may calculate a gradient of each of a plurality of pixels of an image by positioning the center of the boundary line detection mask on each of the plurality of pixels of the image, multiplying the pixels located within the region of the boundary line detection mask by the weights of the boundary line detection mask, respectively, and summing all the results. In an embodiment, when a plurality of boundary line masks 300 are provided for calculating gradients for a plurality of directions, the electronic device 2000 may calculate gradients of the plurality of pixels for the plurality of directions by applying the plurality of boundary line masks 300 to the grayscale-converted original image 110.

In an embodiment, the electronic device 2000 may calculate magnitudes of the gradients of the plurality of pixels, and identify whether the calculated magnitudes of the gradients are greater than or equal to a preset threshold value. In an embodiment, the electronic device 2000 may identify, as pixels detected as boundary lines, a plurality of pixels, whose calculated gradient magnitudes are greater than or equal to the preset threshold value, and the magnitudes of the gradients may be calculated based on Equation 2 below.

$$\vert G \vert = \sqrt{{G}_{x}^{2} + {G}_{y}^{2}} \qquad [ Equation 2 ]$$

Equation 2 is used to calculate the magnitude of a gradient |G|. Here, Gₓ may refer to a gradient calculated by the horizontal boundary line detection mask, and G_{y} may refer to a gradient calculated by the vertical boundary line detection mask. However, embodiments of the present disclosure are not limited to the above example, and the magnitude of the gradient may be calculated by further considering gradients for other directions. In addition, a Manhattan distance, rather than a Euclidean distance as in Equation 2, may be calculated as the magnitude of the gradient.

In an embodiment, the electronic device 2000 may perform various image processing operations together with the embodiments disclosed in the present specification in order to detect the boundary lines 120 by applying the boundary line detection mask 300 to the original image 110. For example, the electronic device 2000 may further perform at least one image processing operation from among Gaussian smoothing, non-maximum suppression, double thresholding, and edge tracking by hysteresis, as in a Canny algorithm. However, embodiments of the present disclosure are not limited to the above example, and image processing operations included in boundary line detection algorithms other than the Canny algorithm may be further performed, or some image processing operations may be omitted.

FIG. 4 is a flowchart for describing an operation, performed by an electronic device, of detecting boundary lines based on a boundary line thickness, according to an embodiment of the present disclosure. Operations S410 and S420 of FIG. 4 may be included in operation S210 of FIG. 2.

In operation S410, the electronic device 2000 may receive a user input for setting a boundary line thickness. In an embodiment, the electronic device 2000 may set the boundary line thickness based on the received user input. In an embodiment, the boundary line thickness may include a plurality of levels within a preset range, and the electronic device 2000 may set the boundary line thickness to any one of the plurality of levels based on the received user input.

In operation S420, the electronic device 2000 may compare the boundary line thickness that is set based on the received user input, with a preset threshold value. In an embodiment, the preset threshold value may be any one of the plurality of levels that may be set as the boundary line thickness. For example, in a case in which the plurality of levels that may be set as the boundary line thickness includes a total of 20 levels, the preset threshold value may be boundary line thickness level 10, but embodiments of the present disclosure are not limited thereto.

In operation S430, when the set boundary line thickness is identified as being less than the preset threshold value (S420—Y), the electronic device 2000 may determine the size of the boundary line detection mask to be a first size. For example, when the set boundary line thickness is level 2 and the preset threshold value is level 10, the electronic device 2000 may determine the size of the boundary line detection mask to be a first size of 3×3, but embodiments of the present disclosure are not limited thereto.

In operation S440, the electronic device 2000 may apply the boundary line detection mask of the first size to the original image. Because a detailed description of applying the boundary line detection mask to the original image has been provided with reference to FIG. 3, a redundant description thereof will be omitted.

In operation S450, when the set boundary line thickness is identified as being greater than or equal to the preset threshold value (S420—N), the electronic device 2000 may determine the size of the boundary line detection mask to be a second size that is greater than the first size. For example, when the set boundary line thickness is level 12 and the preset threshold value is level 10, the electronic device 2000 may determine the size of the boundary line detection mask to be a second size of 5×5, but embodiments of the present disclosure are not limited thereto.

In operation S460, the electronic device 2000 may apply the boundary line detection mask of the second size to the original image. Because a detailed description of applying the boundary line detection mask to the original image has been provided with reference to FIG. 3, a redundant description thereof will be omitted.

FIG. 5 is a diagram for describing an operation, performed by an electronic device, of detecting boundary lines of different thicknesses by applying, to an original image, boundary line detection masks of different sizes, according to an embodiment of the present disclosure. In FIG. 5, Sobel masks of 3×3 and 5×5 sizes are illustrated as boundary line detection masks, but embodiments of the present disclosure are not limited thereto, and the boundary line detection mask may include a Laplacian mask, a Prewitt mask, a Roberts mask, or the like.

In an embodiment, the electronic device may detect first boundary lines 120-1 by applying a horizontal mask 510-1 and a vertical mask 510-2 of a 3×3 size to the original image 110. In an embodiment, because the first boundary lines 120-1 are detected based on the 3×3 boundary line detection masks, a pixel detected as part of the first boundary lines 120-1 may be identified based on the luminance values of 8 pixels within the region of the boundary line detection masks.

In an embodiment, the electronic device may detect second boundary lines 120-2 by applying a horizontal boundary line mask 520-1 and a vertical boundary line mask 520-2 of a 5×5 size to the original image 110. In an embodiment, because the second boundary lines 120-2 are detected based on the 5×5 boundary line detection masks, pixels detected as the second boundary lines 120-2 may be identified based on the luminance values of 24 pixels within the region of the boundary line detection masks.

In an embodiment, as the size of the boundary line detection mask increases, a gradient indicating the degree of change in the luminance values of a larger number of pixels is calculated, and thus, some pixels that are not detected as boundary lines when using a small boundary line detection mask may be detected as boundary lines when using a large boundary line detection mask. In other words, as the size of the boundary line detection mask applied to the original image increases, the number of pixels detected as boundary lines from the original image increases, and accordingly, the thickness of the boundary lines detected from the original image may increase. For example, as illustrated in FIG. 5, the thicknesses of the second boundary lines 120-2 detected based on the 5×5 boundary line detection masks may be greater than those of the first boundary lines 120-1 detected based on the 3×3 boundary line detection masks.

As such, the electronic device 2000 according to an embodiment of the present disclosure may detect boundary lines of different thicknesses by changing the size of the boundary line detection mask. In this case, because a lower boundary line thickness results in less deviation from the original image, the corrected image 130 may appear more natural to a user. Conversely, because more pixels are converted into binary values as the boundary line thickness increases, the corrected image may be more easily perceived by the user.

FIG. 6 is a flowchart for describing an operation, performed by an electronic device, of detecting boundary lines based on a boundary line thickness, according to an embodiment of the present disclosure. Operations S610, S620, and S630 of FIG. 6 may be included in operation S420 to S460 of FIG. 4, or may be operations performed after operation S410, irrespective of operations S420 to S460 of FIG. 4.

In operation S610, the electronic device 2000 may identify first pixels by applying a boundary line detection mask to an original image. Here, the first pixels may refer to the pixels detected as the boundary lines 120 by applying the boundary line detection mask 300 to the original image 110, as described above with reference to FIG. 3.

In operation S620, the electronic device 2000 may identify second pixels located around the first pixels, based on a set boundary line thickness. In an embodiment, a magnification value for identifying second pixels may be preset for each of a plurality of boundary line thickness levels. In an embodiment, the electronic device 2000 may expand a region formed by the first pixels, by the magnification value corresponding to the set boundary line thickness, and identify, as a second pixel, at least one pixel included in the expanded region. Details regarding this process will be described below with reference to FIG. 7.

In operation S630, the electronic device 2000 may detect, as boundary lines, the identified first pixels and the identified second pixels. In an embodiment, when the set boundary line thickness is the lowest level among a plurality of levels that may be set as the boundary line thickness, the electronic device 2000 may detect the identified first pixels as boundary lines, without identifying second pixels. In an embodiment, when the set boundary line thickness is higher than the lowest level among the plurality of levels that may be set as the boundary line thickness, the electronic device 2000 may detect, as boundary lines, the identified first pixels and the identified second pixels.

In an embodiment, when the set thickness is less than a preset threshold value, the electronic device 2000 may detect, as boundary lines, the identified first pixels and the identified second pixels by applying a boundary line detection mask of a first size to the original image. In an embodiment, when the set thickness is greater than or equal to the preset threshold value, the electronic device 2000 may detect, as boundary lines, the identified first pixels and the identified second pixels by applying a boundary line detection mask of a second size to the original image. In an embodiment, the electronic device 2000 may identify a boundary line thickness at which the total number of first pixels and second pixels identified when the boundary line detection mask of the first size is applied to the original image is closest to the number of first pixels identified when the boundary line detection mask of the second size is applied to the original image. In an embodiment, the electronic device 2000 may determine the identified boundary line thickness as the preset threshold value that serves as a basis for determining the size of a boundary line detection mask.

As such, according to an embodiment of the present disclosure, even when the size of the boundary line detection mask applied to the original image is changed based on a preset threshold value, a boundary line whose thickness is more naturally adjusted may be detected.

FIG. 7 is a diagram for describing an operation, performed by an electronic device, of identifying second pixels located around first pixels that are identified by applying a boundary line detection mask, according to an embodiment of the present disclosure.

In an embodiment, the electronic device 2000 may identify first pixels 710 by applying a boundary line detection mask to an original image. For example, the electronic device 2000 may identify, as the first pixels 710, O18, O19, O25, O31, and O32 from among O1 to O49 that are some of a plurality of pixels of the original image. In an embodiment, when the set boundary line thickness is a first level, which is the lowest level among a plurality of levels that may be set as the boundary line thickness, the electronic device 2000 may detect, as a boundary line, O18, O19, O25, O31, and O32 that are identified as the first pixels 710.

In an embodiment, the electronic device 2000 may expand a region formed by the first pixels 710, by a magnification value corresponding to the set boundary line thickness, and identify, as second pixels 720, at least one pixel included in the expanded region. For example, when the set boundary line thickness is a second level, the electronic device 2000 may expand the region formed by the first pixels 710 by a factor of two in a horizontal direction and by a factor of two in a vertical direction, based on a magnification value of 2 corresponding to the second level. In this case, as the region formed by the first pixels 710 is expanded by 2 times in the horizontal direction, O17, O20, O26, O30, and O33 may be included in the expanded region, and as the region formed by the first pixels 710 is expanded by 2 times in the vertical direction, O4, O11, O12, O24, O39, and O46 may be included in the expanded region. In an embodiment, the electronic device 2000 may identify, as the second pixels 720, O4, O11, O12, O17, O20, O26, O30, O33, O39, and O46 that are included in the expanded region.

In an embodiment, when expanding the region formed by the first pixels 710, each row and column of the region formed by the first pixels 710 may be expanded by an equal length in opposite directions. In an embodiment, the region formed by the first pixels 710 may be expanded to have a longer length in a preset direction or in a randomly selected direction when the number of pixels included in the additional region for each row and column of the region formed by the first pixels 710 is an odd number. For example, when expanding the region of the first pixels 710 in the horizontal direction, the expansion for O25 may be performed such that the region further includes O26, which is one of O24 and O26. In addition, when expanding the region of the first pixels 710 in the vertical direction, the expansion for O19 may be performed such that the region further includes O12, which is one of O12 and O26, and the expansion for O31 may be performed such that the region further includes O24, which is one of O24 and O38.

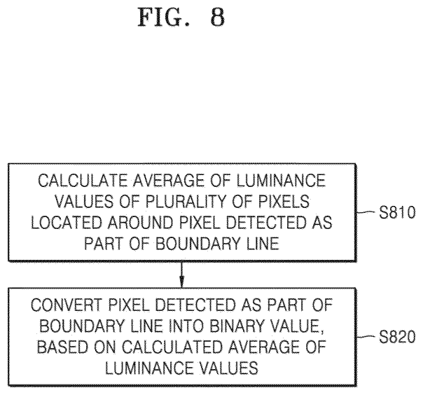

FIG. 8 is a flowchart for describing an operation, performed by an electronic device, of converting pixels detected as boundary lines into binary values, according to an embodiment of the present disclosure. Operations S810 and S820 of FIG. 8 may be included in operation S220 of FIG. 2.

In operation S810, the electronic device 2000 may calculate an average of luminance values of a plurality of pixels located around a pixel detected as part of a boundary line. In an embodiment, the plurality of pixels located around the pixel detected as part of the boundary line may include 8 pixels surrounding the detected pixel. However, embodiments of the present disclosure are not limited to the above example, and the plurality of pixels located around the pixel detected as part of the boundary line may include a plurality of pixels existing within a preset range from the pixel detected as part of the boundary line.

In an embodiment, the electronic device 2000 may identify a plurality of pixels located around a pixel detected as part of a boundary line from among a plurality of pixels of a grayscale-converted original image, and calculate an average of luminance values of the plurality of identified pixels. In an embodiment, the electronic device 2000 may perform min-max scaling normalization on the luminance values of the plurality of identified pixels, and calculate an average of the luminance values of the plurality of pixels on which the normalization has been performed.

In operation S820, the electronic device 2000 may convert the pixel detected as part of the boundary line into a binary value, based on the calculated average of the luminance values.

In an embodiment, the electronic device 2000 may binarize the value of the pixel detected as part of the boundary line to 0 when the calculated average of the luminance values is greater than or equal to a preset threshold value, and binarize the value of the pixel detected as part of the boundary line to 1 when the calculated average of the luminance values is less than the preset threshold value. In an embodiment, the preset threshold value may be set to a middle value between a minimum luminance value and a maximum luminance value that a pixel may have. In an embodiment, when the average of the luminance values of the plurality of pixels is an average of the luminance values of the plurality of pixels on which normalization has been performed, the preset threshold value may be set to a middle value of 0.5. However, embodiments of the present disclosure are not limited to the above example, and the preset threshold value may be set to any one of luminance values that a pixel may have or a normalized luminance value. However, embodiments of the present disclosure are not limited to the above example, and the electronic device 2000 may binarize the value of the pixel detected as part of the boundary line to 1 when the calculated average of the luminance values is greater than or equal to the preset threshold value, and binarize the value of the pixel detected as part of the boundary line to 0 when the calculated average of the luminance values is less than the preset threshold value.

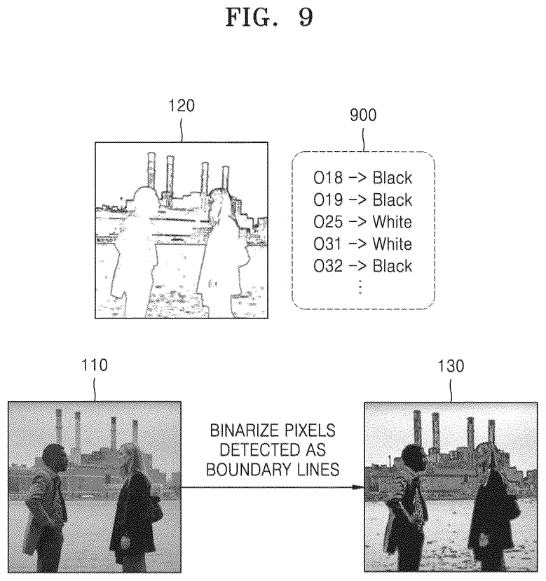

FIG. 9 is a diagram for describing an electronic device converting pixels detected as boundary lines into binary values, according to an embodiment of the present disclosure.

In an embodiment, the electronic device 2000 may detect the boundary lines 120 from the original image 110. For example, as illustrated in FIG. 7, the pixels detected as the boundary lines 120 may include O18, O19, O25, O31, and O32 among a plurality of pixels of the original image.

In an embodiment, the electronic device 2000 may calculate an average of luminance values of a plurality of pixels located around a pixel detected as part of the boundary lines 120. For example, the electronic device 2000 may calculate an average of normalized luminance values of a plurality of pixels, i.e., O10, O11, O12, O17, O24, O26, O31, O32, and O33, located around the pixel O18 detected as part of the boundary lines 120, to be 0.7. In addition, the electronic device 2000 may calculate an average of normalized luminance values of a plurality of pixels, i.e., O17, O18, O19, O24, O26, O31, O32, and O33, located around the pixel O25 detected as part of the boundary lines 120, to be 0.2. In this case, the electronic device 2000 may determine to binarize the pixel value of O18 to 0 based on the calculated average of the normalized luminance values for O18 being greater than or equal to a preset threshold value of 0.5, and determine to binarize the pixel value of O25 to 1 based on the calculated average of the normalized luminance values for O25 being less than the preset threshold value of 0.5.

In an embodiment, the electronic device 2000 may determine a binarization method 900 for the pixels detected as the boundary lines 120 by performing the above-described operations on all the pixels detected as the boundary lines. The electronic device 2000 may obtain the corrected image 130 by converting the values of the pixels detected as the boundary lines 120 among the plurality of pixels of the original image 110 to 0 or 1 according to the determined binarization method 900.

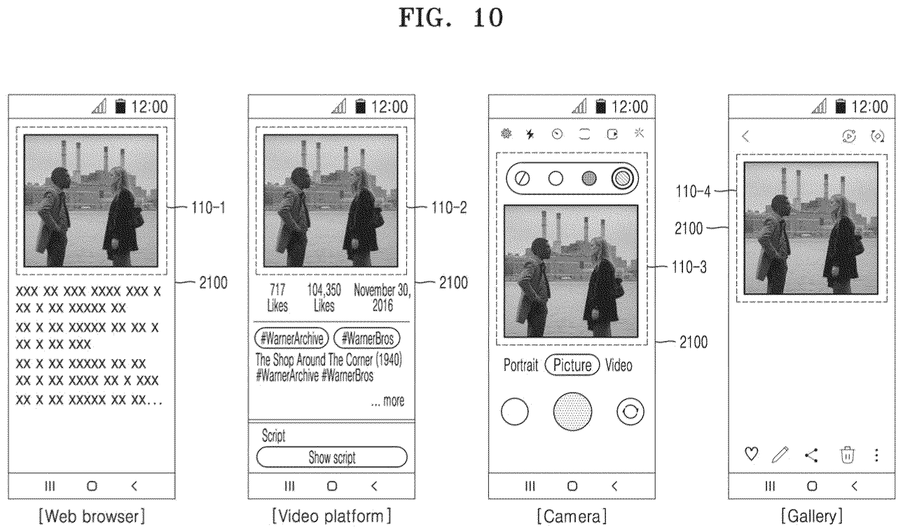

FIG. 10 is a diagram for describing an operation, performed by an electronic device, of obtaining an original image, according to an embodiment of the present disclosure.

In an embodiment, the electronic device 2000 may obtain, as the original image, image content that is displayed on the display when an application is executed.

In an embodiment, the electronic device 2000 may obtain, as the original image, an image 110-1 included in a web page that is displayed on the display 2100 when a web browser application is executed. In an embodiment, the electronic device 2000 may detect boundary lines from the obtained image included in the web page, and obtain a corrected image by converting pixels detected as boundary lines into binary values. In an embodiment, the electronic device 2000 may display the obtained corrected image on the web page.

In an embodiment, the electronic device 2000 may obtain, as the original image, a plurality of frames 110-2 of a video that is displayed on the display 2100 when a video platform application is executed. In an embodiment, the electronic device 2000 may detect boundary lines from the plurality of obtained frames 110-2, and obtain a plurality of corrected images by converting pixels detected as boundary lines into binary values. In an embodiment, the electronic device 2000 may display the obtained corrected images as a video by arranging them as a plurality of frames.

In an embodiment, the electronic device 2000 may obtain, as the original image, a screen 110-3 showing a subject to be photographed by a camera, which is displayed on the display 2100 when a camera application is executed. In an embodiment, the electronic device 2000 may detect boundary lines from the obtained screen 110-3 showing the subject to be photographed by the camera, and obtain a corrected image by converting pixels detected as boundary lines into binary values. In an embodiment, the electronic device 2000 may display the corrected image as a corrected screen showing the subject to be photographed by the camera.

In an embodiment, the electronic device 2000 may obtain, as the original image, a photograph 110-4 stored in the electronic device 2000, which is displayed on the display 2100 when a gallery application is executed. In an embodiment, the electronic device 2000 may detect boundary lines from the obtained stored photograph, and obtain a corrected image by converting pixels detected as boundary lines into binary values. In an embodiment, the electronic device 2000 may display the corrected image as the stored photograph.

As such, according to an embodiment of the present disclosure, when a user utilizes various applications of the electronic device 2000, the visibility of image content displayed in the applications may be improved.

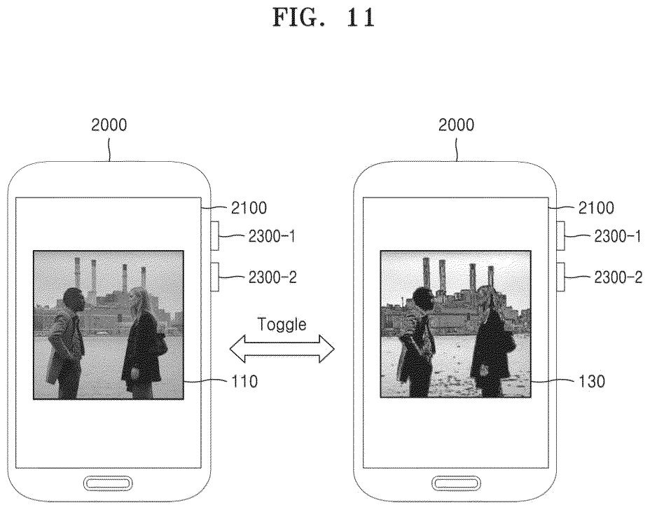

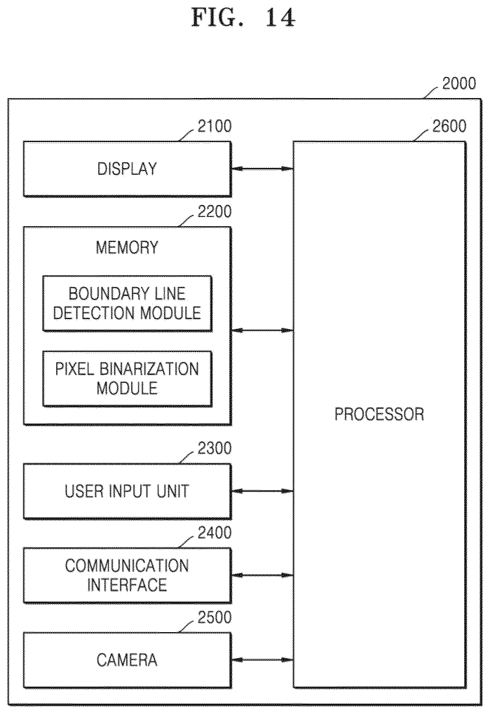

FIG. 11 is a diagram for describing an operation, performed by an electronic device, of activating an operation mode for displaying a corrected image, according to an embodiment of the present disclosure. A first button 2300-1 and a second button 2300-2 illustrated in FIG. 11 may be included in a user input unit 2300 of FIG. 14.

In an embodiment, the electronic device 2000 may receive a user input for executing an operation mode for displaying a corrected image. In an embodiment, the electronic device 2000 may obtain an original image as the operation mode for displaying a corrected image is activated by the received user input. For example, the electronic device 2000 may display the original image 110 on the display 2100 when the operation mode for displaying a corrected image is deactivated, and may obtain the original image 110 and display the corrected image 130 on the display when the operation mode for displaying the corrected image is activated.

In an embodiment, the electronic device 2000 may include the first button 2300-1 and the second button 2300-2 for receiving a user input for executing the operation mode for displaying a corrected image. In an embodiment, based on detecting a user input for at least one of the first button 2300-1 and the second button 2300-2, the electronic device 2000 may activate the operation mode for displaying a corrected image. For example, when a user input of simultaneously pressing the first button 2300-1 and the second button 2300-2 is received, the electronic device 2000 may activate the operation mode for displaying a corrected image. In addition, the electronic device 2000 may activate the operation mode for displaying a corrected image, while a user input of simultaneously pressing the first button 2300-1 and the second button 2300-2 is being received, and deactivate the operation mode for displaying a corrected image, when the reception of the user input of simultaneously pressing the first button 2300-1 and the second button 2300-2 is stopped. However, embodiments of the present disclosure are not limited to the above example, and the electronic device 2000 may include only one of the first button 2300-1 and the second button 2300-2, or may activate or deactivate the operation mode for displaying a corrected image, based on receiving a user input for at least one of various types of first buttons 2300-1 and second buttons 2300-2.

In an embodiment, the first button 2300-1 and the second button 2300-2 of the electronic device 2000 may be buttons for executing other functions of the electronic device 2000. For example, the first button 2300-1 may be a button for adjusting the volume of the electronic device, and the second button 2300-2 may be a button for controlling the power of the electronic device. In an embodiment, the electronic device 2000 may set, based on a user input, a manipulation of at least one of the first button 2300-1 and the second button 2300-2 to activate the operation mode for displaying a corrected image.

As such, according to an embodiment of the present disclosure, because a user may more freely and quickly control the activation of display of a corrected image, the usability of the corrected image display function may be enhanced.

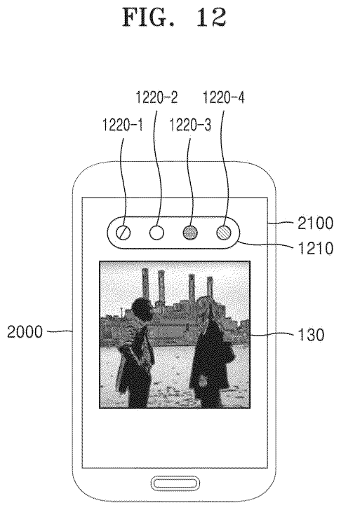

FIG. 12 is a diagram for describing an operation, performed by an electronic device, of changing a color of a boundary line in a corrected image, according to an embodiment of the present disclosure.

In an embodiment, the electronic device 2000 may receive a user input for setting a boundary line color. In an embodiment, the electronic device 2000 may display a color selection user interface (UI) 1210 for receiving a user input for setting a boundary line color, on the display 2100 along with the corrected image 130. In an embodiment, the color selection UI 1210 may include an icon 1220-1 for deactivating the display of the corrected image, an icon 1220-2 for selecting a first color, an icon 1220-3 for selecting a second color, and an icon 1220-4 for selecting a third color. In an embodiment, the icon 1220-2 for selecting the first color, the icon 1220-3 for selecting the second color, and the icon 1220-4 for selecting the third color may be displayed in the first color, the second color, and the third color, respectively.

In an embodiment, the electronic device 2000 may receive a user input for selecting the icon 1220-1 for deactivating the display of the corrected image. In an embodiment, in response to receiving a user input for selecting the icon 1220-1 for deactivating the display of the corrected image, the electronic device 2000 may display, instead of the corrected image 130, the original image that is a basis for obtaining the corrected image 130.

In an embodiment, when the original image is displayed, the electronic device 2000 may display an icon for activating the display of the corrected image. In an embodiment, the electronic device 2000 may receive a user input for selecting the icon for activating the display of the corrected image. In an embodiment, in response to receiving a user input for selecting the icon for activating the display of the corrected image, the electronic device 2000 may again display the corrected image 130 on the display 2100, instead of the original image. However, embodiments of the present disclosure are not limited to the above example, and the electronic device 2000 may display the corrected image 130 together with the original image.

In an embodiment, the electronic device 2000 may receive a user input for selecting any one of the icon 1220-2 for selecting the first color, the icon 1220-3 for selecting the second color, and the icon 1220-4 for selecting the third color. In an embodiment, in response to receiving the user input, the electronic device 2000 may set, as the boundary line color, a color corresponding to the icon selected by the user input. In an embodiment, when the boundary line color is set, the electronic device 2000 may convert pixel values representing the colors of pixels converted into binary values in the corrected image 130, to correspond to the set boundary line color. For example, in response to receiving a user input for selecting the icon 1220-2 for selecting the first color, the electronic device 2000 may convert, to the first color, the pixel values representing the colors of the pixels converted into binary values in the corrected image 130, and display the resulting image on the display 2100.

As such, according to an embodiment of the present disclosure, the boundary lines in the corrected image 130 may be changed to a color desired by a user and then displayed, without being displayed in only white and black.

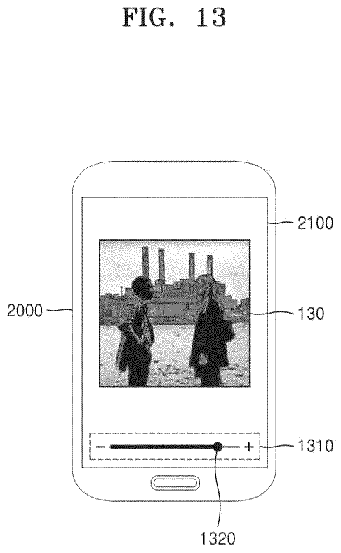

FIG. 13 is a diagram for describing an operation, performed by an electronic device, of changing the transparency of a corrected image, according to an embodiment of the present disclosure.

In an embodiment, the electronic device 2000 may receive a user input for setting image transparency. In an embodiment, the electronic device 2000 may display a transparency setting UI 1310 for receiving a user input for setting image transparency, on the display 2100 along with the corrected image 130. In an embodiment, the transparency setting UI 1310 may include a handler 1302 that moves along a scroll bar.

In an embodiment, the electronic device 2000 may receive a user input for changing the position of the handler 1320 included in the transparency setting UI 1310. In an embodiment, the electronic device 2000 may set the image transparency based on the position of the handler 1320 on the scroll bar. In an embodiment, when the image transparency is determined, the electronic device 2000 may convert pixel values representing the transparency of pixels other than those converted into binary values in the corrected image 130, to a value corresponding to the determined transparency. For example, in response to obtaining a user input for positioning the handler 1320 at the center of the scroll bar, the electronic device 2000 may convert alpha channel values, which are pixel values representing the transparency of the pixels other than those converted into binary values in the corrected image 130, to 0.5.

In an embodiment, the electronic device 2000 may further include a boundary line thickness setting UI. The boundary line thickness setting UI may be similar in function and form to the transparency setting UI 1310 of FIG. 13. In an embodiment, the electronic device 2000 may display the boundary line thickness setting Ul on the display 2100 along with the corrected image 130. In an embodiment, the electronic device 2000 may receive a user input for manipulating a handler included in the boundary line thickness setting Ul. In an embodiment, the electronic device 2000 may set the boundary line thickness based on the received user input.

As such, according to an embodiment of the present disclosure, the visibility of the boundary lines may be further emphasized by adjusting the transparency of the pixels other than the boundary lines in the corrected image 130. In addition, because a user may adjust the image transparency and/or the boundary line thickness while viewing the corrected image 130, the user convenience may be enhanced.

FIG. 14 is a diagram for describing a detailed configuration of an electronic device according to an embodiment of the present disclosure.

Referring to FIG. 14, the electronic device 2000 may include the display 2100, memory 2200, the user input unit 2300, a communication interface 2400, a camera 2500, and at least one processor 2600. The display 2100, the memory 2200, the user input unit 2300, the communication interface 2400, the camera 2500, and the at least one processor 2600 may be electrically and/or physically connected to each other.

The components illustrated in FIG. 14 are merely examples according to an embodiment of the present disclosure, and the components included in the electronic device 2000 are not limited to those illustrated in FIG. 14. The electronic device 2000 according to an embodiment of the present disclosure may not include some of the components illustrated in FIG. 14, and may further include components that are not illustrated in FIG. 14.

The display 2100 is a component for displaying an image and/or a video. In an embodiment, the display 2100 may include any one of a liquid-crystal display, a plasma display, an organic light-emitting diode display, and an inorganic light-emitting diode display. However, embodiments of the present disclosure are not limited to the above example, and the display 2100 may include other types of displays capable of displaying an image and/or a video. In an embodiment, the display 2100 may display an original image and/or a corrected image. However, embodiments of the present disclosure are not limited to the above example, and the display 2100 may further display an application screen, a user interface, or the like for performing the operations and functions of the electronic device 2000 described herein with reference to various embodiments.

In an embodiment, the memory 2200 may include at least one of flash memory-type memory, hard disk-type memory, multimedia card micro-type memory, card-type memory (e.g., Secure Digital (SD) or extreme Digital (XD) memory), random-access memory (RAM), static RAM (SRAM), read-only memory (ROM), electrically erasable programmable ROM (EEPROM), programmable ROM (PROM), mask ROM, flash ROM, a hard disk drive (HDD), or a solid-state drive (SSD).

The memory 2200 may store Instructions or program code for performing functions or operations of the electronic device 2000. In an embodiment, at least one instruction, algorithm, data structure, program code, and application program stored in the memory 2200 may be implemented in a programming or scripting language such as C, C++, Java, or an assembler.

In an embodiment, the memory 2200 may include a boundary line detection module configured to perform an operation and function of detecting boundary lines from an image, and a pixel binarization module configured to perform an operation and function of converting a particular pixel of an image into a binary value. However, embodiments of the present disclosure are not limited to the above example, and may further include modules necessary for performing the operations and functions of the electronic device 2000 described herein with reference to various embodiments. In an embodiment, a ‘module’ stored in the memory 2200 may refer to a unit that processes a function or operation performed by the processor 2600, and may be implemented as software, such as at least one instruction, algorithm, data structure, or program code.

The user input unit 2300 is a component for receiving various user inputs. In an embodiment, the user input unit 2300 may include a touch panel, physical buttons, or the like. In an embodiment, the touch panel may be integrated into the display 2100, or may be a component separate from the display 2100. In an embodiment, the user input unit 2300 may include at least one of a user input unit configured to receive a user input for setting a boundary line thickness, a user input unit configured to receive a user input for setting a boundary line color, a user input unit configured to receive a user input for setting image transparency, and a user input unit configured to receive a user input for executing an operation mode for displaying a corrected image. However, embodiments of the present disclosure are not limited to the above example, and a user input necessary for performing the operations and functions of the electronic device 2000 disclosed herein with reference to various embodiments may be received through the user input unit 2300.

The communication interface 2400 is a component for the electronic device 2000 to perform communication with an external electronic device. In an embodiment, the communication interface 2400 may perform data communication with an external electronic device 2000 by using at least one of data communication schemes including, for example, wired local area network (LAN), wireless LAN, Wi-Fi, Bluetooth, ZigBee, Wi-Fi Direct (WFD), Infrared Data Association (IrDA), Bluetooth Low Energy (BLE), near-field communication (NFC), wireless broadband internet (WiBro), Worldwide Interoperability for Microwave Access (WiMAX), Shared Wireless Access Protocol (SWAP), Wireless Gigabit Alliance (WiGig), and radio-frequency (RF) communication. In an embodiment, the communication interface 2400 may receive an original image and/or a user input from an external electronic device, or transmit a corrected image to an external electronic device. However, embodiments of the present disclosure are not limited to the above example, and various types of data for performing the operations and functions of the electronic device 2000 disclosed herein with reference to various embodiments may be transmitted and received through the communication interface 2400.

The camera 2500 is a component configured to obtain an image of a real object in a real space by photographing the real space. In an embodiment, the camera 2500 may include a single camera, or may include three or more multi-cameras. In an embodiment, the camera 2500 may include a lens module, an image sensor, and an image processing module. The camera 2500 may obtain a still image or a video obtained by the image sensor (e.g., a complementary metal-oxide-semiconductor (CMOS) sensor or a charge-coupled device (CCD)). The image processing module may extract necessary information by processing a still image or a video obtained through the image sensor. In an embodiment, an image captured by the camera 2500 may be provided to the at least one processor 2600 as an original image.

The at least one processor 2600 may execute one or more instructions of a program stored in the memory 2200. The at least one processor 2600 may include a hardware component that performs arithmetic, logic, and input/output operations, and signal processing. For example, the at least one processor 2600 may include at least one of a CPU, a microprocessor, a GPU, an application-specific integrated circuit (ASIC), a digital signal processor (DSP), a digital signal processing device (DSPD), a programmable logic device (PLD), and a field-programmable gate array (FPGA), but is not limited thereto.

In an embodiment, the at least one processor 2600 may detect a boundary line from an original image. In an embodiment, the at least one processor 2600 may obtain a corrected image by converting a pixel detected as part of the boundary line into a binary value based on luminance values of a plurality of pixels located around the pixel detected as part of the boundary line. In an embodiment, the at least one processor 2600 may display the obtained corrected image on the display 2100.

In an embodiment, the at least one processor 2600 may calculate an average of the luminance values of the plurality of pixels located around the pixel detected as part of the boundary line. In an embodiment, the at least one processor 2600 may convert the pixel detected as part of the boundary line into the binary value, based on the calculated average of the luminance values.

In an embodiment, the at least one processor 2600 may binarize, based on the calculated average of the luminance values being greater than or equal to a preset threshold value, a value of the pixel detected as part of the boundary line to 0. In an embodiment, the at least one processor 2600 may binarize, based on the calculated average of the luminance values being less than the preset threshold value, the value of the pixel detected as part of the boundary line to 1. However, embodiments of the present disclosure are not limited to the above example, and the at least one processor 2600 may binarize, based on the calculated average of the luminance values being greater than or equal to the preset threshold value, the value of the pixel detected as part of the boundary line to 1, and binarize, based on the calculated average of the luminance values being less than the preset threshold value, the value of the pixel detected as part of the boundary line to 0.

In an embodiment, the pixel detected as part of the boundary line and converted into the binary value may be displayed as black on the display based on the value of the pixel being binarized to 0. In an embodiment, the pixel detected as part of the boundary line and converted into the binary value may be displayed as white on the display based on the value of the pixel being binarized to 1.

In an embodiment, the at least one processor 2600 may detect the boundary line by applying a boundary line detection mask to the original image. In an embodiment, the at least one processor 2600 may receive a user input for setting a boundary line thickness.

In an embodiment, the at least one processor 2600 may determine a size of the boundary line detection mask based on a result of comparing the boundary line thickness that is set based on the received user input, with a preset threshold value. In an embodiment, the at least one processor 2600 may apply the boundary line detection mask having the determined size to the original image.

In an embodiment, the at least one processor 2600 may identify a first pixel by applying the boundary line detection mask to the original image. In an embodiment, the at least one processor 2600 may identify a second pixel located around the first pixel based on the set boundary line thickness. In an embodiment, the at least one processor 2600 may detect, as the boundary line, the identified first pixel and the identified second pixel.

In an embodiment, the at least one processor 2600 may receive a user input for setting a boundary line color. In an embodiment, the at least one processor 2600 may convert a pixel value, which represents a color of the pixel converted into the binary value in the corrected image, to correspond to a boundary line color that is set based on the received user input.

In an embodiment, the at least one processor 2600 may receive a user input for setting image transparency. In an embodiment, the at least one processor 2600 may convert pixel values representing the transparency of other pixels than the pixel converted into the binary value in the corrected image, to a value corresponding to the image transparency that is set via the received user input. In an embodiment, the at least one processor 2600 may obtain, as an original image, image content that is displayed on the display 2100 when an application is executed.

In an embodiment, the at least one processor 2600 may receive a user input for executing an operation mode for displaying a corrected image. In an embodiment, the at least one processor 2600 may obtain an original image as the operation mode is activated by the received user input.

In an embodiment, the at least one processor 2600 may perform the operations and functions of the electronic device 2000 described herein with reference to various embodiments, including the above embodiments, and redundant descriptions thereof will be omitted.

As such, the electronic device 2000 according to an embodiment of the present disclosure may improve the visibility of an image or a video by displaying, on the display 2100, the corrected image 130, which enables higher contrast sensitivity for the boundary lines 120 compared to the original image 110.

The computer-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment, methods according to various embodiments disclosed herein may be included in a computer program product and then provided. The computer program product may be traded as a commodity between sellers and buyers. The computer program product may be traded as a commodity between sellers and buyers. The computer program product may be distributed in the form of a machine-readable storage medium (e.g., a compact disc ROM (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or memory of a relay server.

Although example embodiments have been described and shown, various modifications and changes may be made by those of skill in the art from the above description. For example, suitable results may be obtained even when the described techniques are performed in a different order, or when components in a described electronic device, architecture, device, or circuit are coupled or combined in a different manner, or replaced or supplemented by other components or their equivalents.

What is claimed is:

1. An electronic device for displaying an image, the electronic device comprising:
a display;
memory storing at least one instruction; and
at least one processor configured to execute the at least one instruction stored in the memory,
wherein the at least one instruction, when executed by the at least one processor individually or collectively, causes the electronic device to:
detect a boundary line from an original image,
obtain a corrected image by converting a pixel detected as part of the boundary line into a binary value based on luminance values of a plurality of pixels located around the pixel detected as the part of the boundary line, and
display the corrected image via the display.

2. The electronic device of claim 1, wherein the at least one instruction, when executed by the at least one processor individually or collectively, causes the electronic device to:
determine an average of the luminance values of the plurality of pixels located around the pixel detected as the part of the boundary line, and
convert the pixel detected as the part of the boundary line into the binary value, based on the average of the luminance values.

3. The electronic device of claim 2, wherein the at least one instruction, when executed by the at least one processor individually or collectively, causes the electronic device to:
based on the average of the luminance values being greater than or equal to a preset threshold value, binarize a value of the pixel detected as the part of the boundary line to 0, and
based on the average of the luminance values being less than the preset threshold value, binarize the value of the pixel detected as the part of the boundary line to 1.

4. The electronic device of claim 3, wherein the pixel detected as the part of the boundary line and converted into the binary value is displayed as black on the display based on the value of the pixel being binarized to 0, and is displayed as white on the display based on the value of the pixel being binarized to 1.

5. The electronic device of claim 1, wherein the at least one instruction, when executed by the at least one processor individually or collectively, causes the electronic device to detect the boundary line by applying a boundary line detection mask to the original image.

6. The electronic device of claim 5, further comprising a user input unit configured to receive a user input for setting a boundary line thickness, wherein the at least one instruction, when executed by the at least one processor individually or collectively, causes the electronic device to:
determine a size of the boundary line detection mask based on a result of comparing the boundary line thickness that is set based on the user input, with a preset threshold value, and
apply the boundary line detection mask having the size to the original image.

7. The electronic device of claim 5, wherein the at least one instruction, when executed by the at least one processor individually or collectively, causes the electronic device to:
identify a first pixel by applying the boundary line detection mask to the original image,
identify a second pixel located around the first pixel based on the boundary line thickness, and
detect, as the boundary line, the first pixel and the second pixel.

8. A method of controlling an electronic device for displaying an image, the method comprising:
detecting a boundary line from an original image;
obtaining a corrected image by converting a pixel detected as part of the boundary line into a binary value based on luminance values of a plurality of pixels located around the pixel detected as the part of the boundary line; and
displaying the corrected image on a display of the electronic device.

9. The method of claim 8, wherein the obtaining the corrected image comprises:
determining an average of the luminance values of the plurality of pixels located around the pixel detected as the part of the boundary line; and
converting the pixel detected as the part of the boundary line into the binary value, based on the average of the luminance values.

10. The method of claim 9, wherein the converting of the pixel detected as the part of the boundary line into the binary value based on the average of the luminance values comprises:
based on the average of the luminance values being greater than or equal to a preset threshold value, binarizing a value of the pixel detected as the part of the boundary line to 0; and
based on the average of the luminance values being less than the preset threshold value, binarizing the value of the pixel detected as the part of the boundary line to 1.

11. The method of claim 10, wherein the pixel detected as the part of the boundary line and converted into the binary value is displayed as black on the display based on the value of the pixel being binarized to 0, and is displayed as white on the display based on the value of the pixel being binarized to 1.

12. The method of claim 8, wherein the detecting the boundary line comprises detecting the boundary line by applying a boundary line detection mask to the original image.

13. The method of claim 12, wherein the detecting the boundary line by applying the boundary line detection mask comprises:
receiving a user input for setting a boundary line thickness;
determining a size of the boundary line detection mask based on a result of comparing the boundary line thickness that is set based on the user input, with a preset threshold value; and
applying the boundary line detection mask having the size to the original image.

14. The method of any one of claim 12, wherein the detecting the boundary line by applying the boundary line detection mask comprises:
identifying a first pixel by applying the boundary line detection mask to the original image;
identifying a second pixel located around the first pixel based on the boundary line thickness; and
detecting, as the boundary line, the first pixel and the second pixel.

15. A non-transitory computer-readable recording medium having recorded thereon a program that when executed by at least one processor of an electronic device, cause the electronic device to prepare a method of comprising:
detect a boundary line from an original image,
obtain a corrected image by converting a pixel detected as part of the boundary line into a binary value based on luminance values of a plurality of pixels located around the pixel detected as the part of the boundary line, and
display the corrected image via a display of the electronic device.
